(19) United States
(12) Patent Application Publication
(10) Pub. No.: US 2025/0030457 A1
(43) Pub. Date: Jan. 23, 2025

(54) CONTROL METHOD FOR AN NFC DEVICE

(71) Applicant: STMicroelectronics International N.V., Geneva (CH)

(72) Inventors: Jeremy QUIGNON, Tourves (FR); Nicolas CORDIER, Aix-en-Provence (FR)

(21) Appl. No.: 18/763,289

(22) Filed: Jul. 3, 2024

(30) Foreign Application Priority Data
Jul. 21, 2023 (FR) 2307840

(51) Int. Cl. H04B 5/70; H01Q 1/24; H02J 50/20; H04B 5/43

(52) U.S. Cl. CPC H04B 5/70; H01Q 1/243; H02J 50/20; H04B 5/43

(57) ABSTRACT

The present description concerns a method of controlling a first NFC device comprising an NFC controller coupled to an antenna, wherein a mode of charge of a second remote NFC device by the antenna is interrupted as a result of a detection, by the NFC controller, of an impedance change of the antenna, the interruption being followed by the starting of a communication, via the antenna, with a third remote NFC device.

### CROSS REFERENCE TO RELATED APPLICATIONS

This application claims the priority benefit of French patent application number FR2307840, filed on Jul. 21, 2023, entitled “Procédé de commande d'un dispositif NFC”, which is hereby incorporated by reference to the maximum extent allowable by law.

### TECHNICAL FIELD

The present disclosure generally concerns methods of controlling NFC (Near Field Communication) devices and associated NFC devices.

### BACKGROUND

NFC communication devices are becoming more and more common, and are used in many electronic devices and more particularly cell phones (smartphones).

NFC protocols, as defined by the NFC Forum, allow the communication or the charging of NFC devices. However, current devices do not enable to implement these two functions efficiently and while minimizing the manufacturing cost.

### BRIEF SUMMARY

There exists a need to improve NFC devices as well as their control methods.

An embodiment overcomes all or part of the disadvantages of known NFC methods and devices.

An embodiment provides a method of controlling a first NFC device comprising an NFC controller coupled to an antenna, wherein a mode of charge of a second remote NFC device by the antenna is interrupted as a result of a detection, by the NFC controller, of an impedance change of the antenna, the interruption being followed by the starting of a communication, via the antenna, with a third remote NFC device.

An embodiment provides an NFC device comprising an NFC controller coupled to an antenna;
the NFC controller being configured to interrupt a mode of charge of a second remote NFC device by the antenna as a result of a detection, by the NFC controller, of an impedance change of the antenna;
the interruption being followed by the starting of a communication, via the antenna, with a third remote NFC device.

In an embodiment, the antenna comprises at least two windings in series.

In an embodiment, said windings comprise one or a plurality of turns.

In an embodiment, the number of turns of one of the windings is in the range from 6 to 8 inclusive.

In an embodiment, one among said windings defines a first surface and a second winding defines a second surface, the first surface being at least twice as large as the second surface.

In an embodiment, one of said windings is arranged within another one of said windings.

In an embodiment, one of said windings is arranged outside of another one of said windings.

In an embodiment, the antenna comprises two windings; one of said windings being adapted to the NFC charging of the second NFC device and the other to the NFC detection and communication with the third NFC device.

In an embodiment, the antenna comprises another winding, in series with said two windings, and adapted to the NFC charging of a fourth NFC device.

In an embodiment, as a result of the detection, the NFC controller implements a polling mode.

In an embodiment, the charge mode is resumed at the end of the communication.

An embodiment provides a cell phone comprising a device such as described hereabove and configured to implement the method such as described hereabove.

An embodiment provides a system comprising:
a telephone such as described hereabove;
a second NFC device; and
a third NFC device.

In an embodiment, the second device is a stylus.

In an embodiment, the system comprises a fourth NFC device, the second and the fourth NFC devices being NFC devices configured to emit sounds.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 shows a simplified view of an example of an NFC communication system;

FIG. 2 shows a simplified view of an NFC communication system according to an embodiment;

FIG. 3 shows an embodiment of an antenna of the system of FIG. 2;

FIG. 4 shows a method of controlling the NFC device of FIG. 2 according to an embodiment;

FIG. 5 shows an example of implementation of the control method of FIG. 4; and

FIG. 6 shows another example of implementation of the control method of FIG. 4.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the steps and elements that are useful the for understanding of the described embodiments have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “edge”, “back”, “top”, “bottom”, “left”, “right”, etc., or relative positions, such as terms “above”, “under”, “upper”, “lower”, etc., or to terms qualifying directions, such as terms “horizontal”, “vertical”, etc., it is referred, unless specified otherwise, to the orientation of the drawings or to an integrated circuit package in a normal position of use.

Unless specified otherwise, the expressions “about”, “approximately”, “substantially”, and “in the order of” signify plus or minus 10%, preferably of plus or minus 5%.

NFC or, in other words, near field communication systems use a radio frequency electromagnetic field generated by a device (terminal or reader) to communicate with another device (card). A same device may, particularly in the case of cell phones, operate in reader mode generating a field for another device, or in card mode capturing a field generated by another device. This technology concerns the establishing of very short-distance communications (shorter than some ten centimeters) between two devices.

This NFC technology further enables an NFC device to charge one or a plurality of other NFC devices placed nearby.

In the present description, the case of a system where the NFC devices are compatible with the NFC technology according to the NFC Forum is considered.

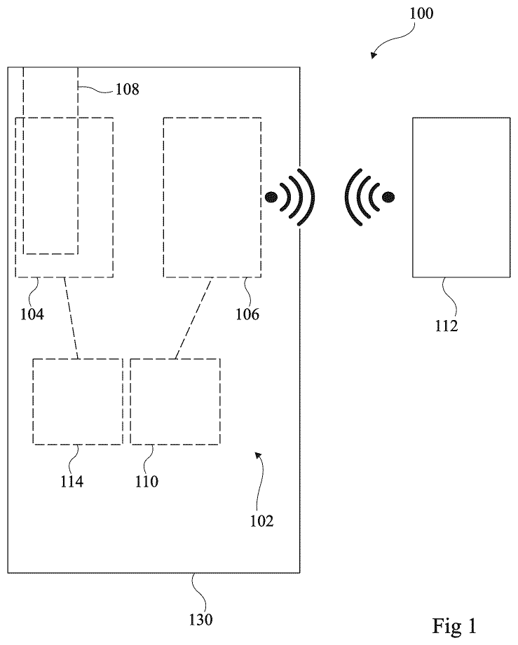

FIG. 1 shows a simplified view of an NFC communication system 100.

NFC system 100 comprises an electronic device 130, for example a telephone or smartphone, implementing a first NFC device 102, which comprises a first and a second antennas 104, 106. The system for example also comprises a second NFC device 108, for example, a stylus, which is configured, for example, to be inserted into smartphone 130. System 100 also for example comprises a third NFC device 112 external to first device 102 or electronic device 130.

First device 102 for example comprises two NFC controllers 110, 114 coupled, preferably connected, respectively to antenna 106 and 104 by one or a plurality of impedance matching circuits—not shown—.

Antenna 104 for example comprises one or a plurality of turns having a shape adapted to concentrating the electromagnetic field towards second device 108.

Antenna 106 for example comprises one or a plurality of turns having a shape adapted to detecting and communicating with third device 112 when the latter enters the near field of interaction provided by the NFC protocol.

A 13.56-MHz electromagnetic field is used between the first and the third NFC device to obtain an NFC communication with for example a legacy mode, either in reader or card mode.

The charge of second NFC device 108 is performed at the same frequency via antenna 104, with second NFC device 108 in a listener mode and NFC controller 114 in a poller, or polling, mode. The polling mode consists in the transmission of periodic electromagnetic field bursts.

In the example of FIG. 1, the fact for there to be one NFC controller per antenna enables to charge the second NFC device and at the same time detect and communicate with third NFC device 112. However, this example is expensive to manufacture.

It is possible to envisage using a single NFC controller instead of controllers 110 and 114, and to use a single antenna. However, in this case, a detection of other NFC objects cannot be implemented during the charge mode. In this case, it could be envisaged to alternate phases of charge and of search for a remote device. However, this decreases the charging efficiency.

The described embodiments provide a method of controlling the first NFC device (102) comprising an NFC controller coupled to an antenna, where a mode of charge of the second remote NFC device by the antenna is interrupted as a result of a detection, by the NFC controller, of an impedance change of the antenna, the interruption being followed by the starting of a communication, via the antenna, with the third remote device.

This enables to detect the third remote device to be detected while charging the second device. The efficiency of the charge and of the detection are not degraded as compared with the example of FIG. 1, while saving component costs.

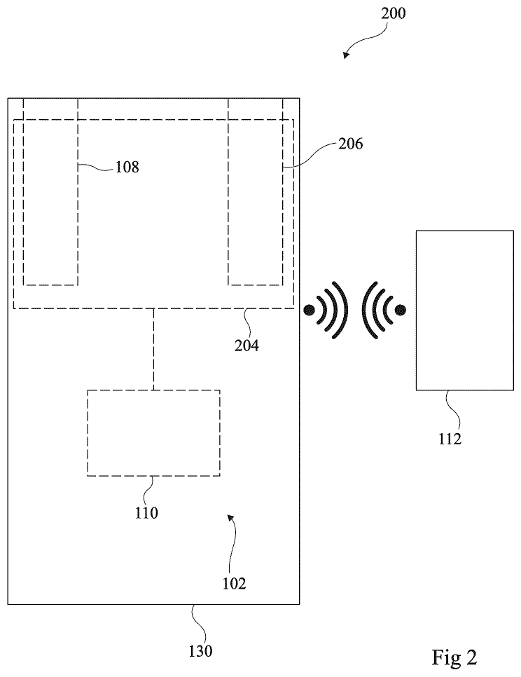

FIG. 2 shows a simplified view of an NFC communication system 200 according to an embodiment.

NFC system 200 is similar to the system 100 of FIG. 1, except that the first NFC device 102 comprises a single NFC antenna 204 instead of the first and second antennas 104, 106. The first NFC device 102 of FIG. 2 further comprises a single NFC controller 110 coupled, preferably connected, to antenna 204 by an impedance matching circuit—not shown—.

Antenna 204 is configured to cover a portion of the NFC device 108 sensitive to the NFC field and also extends more widely within the device 130 to be able to be used to detect the remote NFC device 112.

In the illustrated example, a fourth, optional NFC device 206 forms part of system 200. This NFC device 206 is arranged, for example, within device 206 and has a portion sensitive to the NFC field which is stacked on a portion of antenna 204 so that it can be charged. In this case, NFC devices 108 and 206 are, for example, NFC devices configured to emit sounds, such as headphones, otherwise known as headsets, or also a stylus and a headphone.

The example of FIG. 2 enables to detect the third remote device 112 while charging the second device 108 as well as the fourth device 206 and this, with the same performance as in the case of FIG. 1 but at a lower production cost.

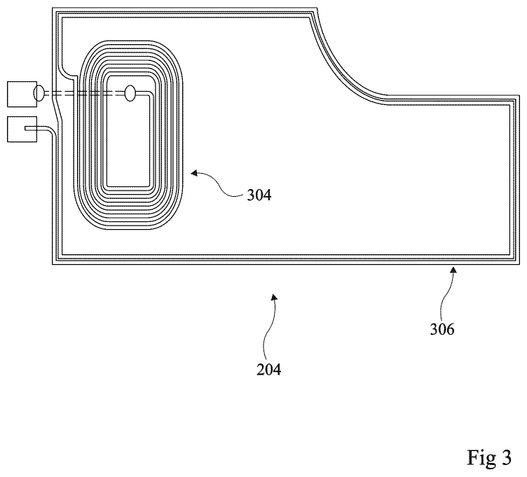

FIG. 3 shows an embodiment of an antenna of the system of FIG. 2. More particularly, FIG. 3 shows antenna 204 in the case where only NFC device 108 is present, since the antenna 204 of FIG. 3 does not apply as such to the case where the optional device 206 is present.

In the shown example, antenna 204 comprises at least two windings 304 and 306 in series. Winding 304 is connected by a terminal to a connection pad and winding 306 is connected by another terminal to another connection pad. Winding 304 comprises 6 turns and winding 306 comprises 2 turns. Winding 304 is positioned to be stacked on device 108. The shape of winding 304 is more compact than the shape of winding 306. This enables to optimize and to locally increase the electromagnetic field at device 108 when the latter has a thin shape, for example in the case of a stylus. The more developed shape of winding 306 enables it to be more sensitive to an electromagnetic field of a remote NFC device, to facilitate its detection, for example.

The number of turns is, for example, in the range from 1 inclusive to 10. In an example, the number of turns of the windings could be chosen between 6 and 8 inclusive to locally focus the intensity of the electromagnetic field. It is however advisable to keep the number of turns below 10 to avoid resonance effects, which should be avoided.

In the shown example, winding 306 defines a first surface and winding 304 defines a second surface. By the term surface, there is meant the area defined within the outermost turn of the windings. In an example, the first surface is at least twice as large as the second surface. The area of the first surface is, for example, greater than 200 mm\hat{ }2 and the area of the second surface smaller than 100 mm\hat{ }2. Having a winding with a smaller area enables not to disturb the winding having the largest area.

In the shown example, winding 304 is arranged within winding 306 and in the same plane. In this case, it should be verified that connection implies a current flowing therethrough which has a same direction, so that the electromagnetic fields do not cancel each other out.

In another example, not shown, winding 304 is arranged outside of winding 306. In this case, the direction of the current is not necessarily the same between the two windings.

Winding 304 is adapted to the charging of NFC device 108 and winding 306 to the NFC communication with NFC device 112.

Winding 304 is arranged to cover as much as possible the NFC antenna of device 108, which enables, in addition to increasing the coupling between the two antennas, not to detect device 108 when a communication is implemented with device 112 via winding 306.

The advantage of having a winding 306 larger than winding 304 is that this enables to prevent device 108 from masking the detection of device 112, while ensuring the charge efficiency with the smaller winding 304.

In the example, not shown, where a fourth NFC device 206 is present in system 200, then an additional winding is provided in antenna 204, for example having a shape similar to winding 304, but arranged to overlap with the portion of device 206 which is sensitive for the NFC charge. This additional winding is, for example, connected in series or in parallel with windings 304 and 306. In this case, the additional winding may be arranged inside or outside of winding 306.

While this is not shown, regions comprising ferrite are for example arranged between antenna 204 and the rest of device 130 to limit electromagnetic interactions.

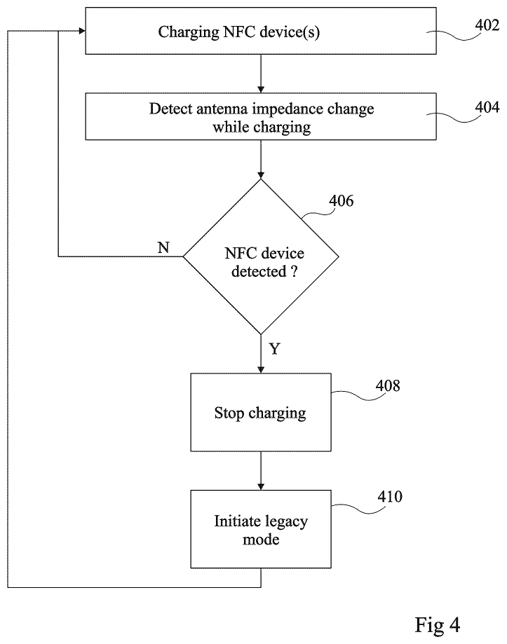

FIG. 4 shows a method of controlling the NFC device of FIG. 2 according to an embodiment.

At a step 402 (Charging NFC device(s)), NFC controller 110 is in a charge mode to charge device 108.

At a step 404 (Detect antenna impedance change while charging), which is for example implemented at the same time as step 402, NFC controller 110 is configured to analyze the impedance variations of antenna 204. In this example, a protocol called Foreign Object Detection (FOD) may be used. If an impedance variation is detected, then a step 406 (NFC device detected?) is implemented. At step 406, NFC controller 110 implements a polling mode if there is an NFC card nearby, and an electrical field detection (EFD) if an NFC device in card or reader mode is recognized, for example device 112 (branch Y), then a step 408 (Stop charging) is implemented. An anti-collision process is for example implemented at this point, to check that there is only one card nearby.

If an NFC device in card or reader mode is not recognized (N branch), for example due to the absence of a NFC device nearby, then step 402 is implemented.

At step 408, the charge mode of device 108 is interrupted.

At a step 410 (Initiate communication with tag or reader), which is implemented at the same time as or after step 408, a legacy mode is implemented by NFC controller 110 for the communication between device 112 via antenna 204 and, more specifically, via winding 306. In an example, low power tag detection (LPTD) is used by the legacy mode.

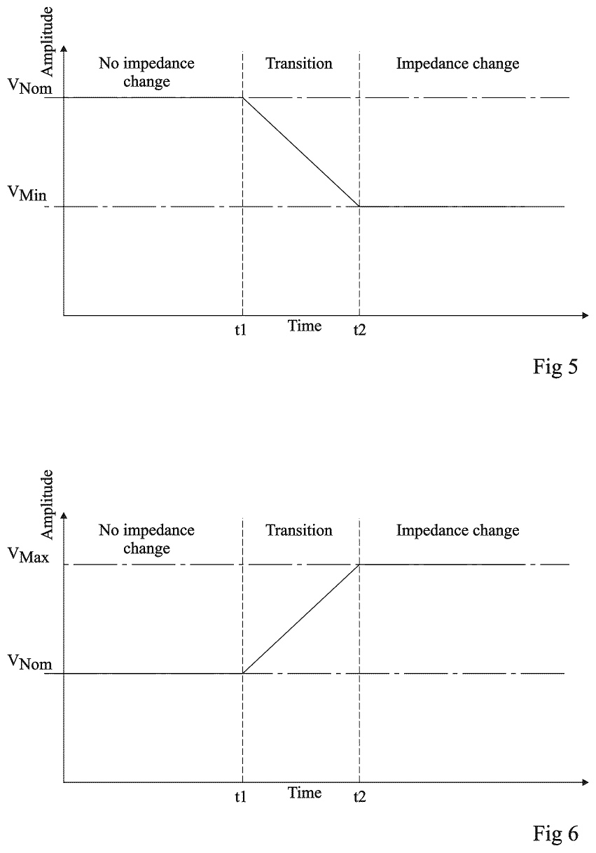

FIG. 5 shows an example of implementation of the control method of FIG. 4. In particular, the example shown in FIG. 5 describes an implementation mode of the detection of the impedance change.

The detection of the impedance change for example consists of in-line and quadrature measurements of the signal captured by the antenna. A calibration is also potentially implemented prior to the measurements to define one or a plurality of thresholds. When the threshold is crossed, then an impedance change is detected. In an example, the threshold is stored in a memory, for example non-volatile, of device 130.

In the shown example, the amplitude of the antenna impedance is expressed in volts as a function of time (Time). Before a time t1 (No impedance change), the impedance is relatively stable at its nominal value VNom. Between time t1 and a subsequent time t2 (Transition), the amplitude decreases, for example linearly, to reach a threshold at VMin and then remains stable at this level VMin. From time t2, an impedance change is detected. In an example, threshold VMin is a percentage of the nominal value obtained by calibration.

FIG. 6 shows another example of implementation of the control method of FIG. 4. More particularly, the example of FIG. 6 describes another implementation mode of the detection of the impedance change.

The example of FIG. 6 is similar to that of FIG. 5, except that the threshold is a voltage VMax which is higher than nominal voltage VNOM. In an example, threshold VMax is a percentage of the nominal value obtained by calibration. Between time t1 and time t2 (Transition), the amplitude for example rises linearly to reach the threshold at VMax and then remains stable at this level VMax. From time t2, an impedance change is detected.

When the communication with device 112 has ended, controller 110 implements step 402 again with the charge of device 108 (or even 206 when it is present).

Various embodiments and variants have been described. Those skilled in the art will understand that certain features of these various embodiments and variants may be combined, and other variants will occur to those skilled in the art. In particular, the method of FIG. 4 for example also applies to the case where a fourth NFC device 206 is used. In this case, those skilled in the art will also stop the charging of device 206 if a communication is implemented with device 112.

Finally, the practical implementation of the described embodiments and variants is within the abilities of those skilled in the art based on the functional indications given hereabove. In particular, regarding the type of communication or of charge implemented by controller 110 through antenna 204, the modulation used is, for example, of type A, B, felica, or also of type V. Those skilled in the art will for example choose between these types so as not to interfere with the other infrastructures of system 200.

1. A method of controlling a first NFC device comprising an NFC controller coupled to an antenna, wherein the method comprises:
interrupting, by the NFC controller, a mode of charge of a second remote NFC device by the antenna as a result of a detection, by the NFC controller, of an impedance change of the antenna; and
starting, following the interrupting, a communication with a third remote NFC device via the antenna.

2. The method of claim 1, wherein the antenna comprises at least two windings in series.

3. The method of claim 2, wherein each of the at least two windings in series comprise a plurality of turns.

4. The method of claim 3, wherein a number of turns of a first winding of the at least two windings is from 6 to 8 turns.

5. The method of claims 2, wherein a first winding of the at least two windings in series defines a first surface and a second winding defines a second surface, wherein the first surface is at least twice as large as the second surface.

6. The method of claim 2, wherein a first winding of the least two windings is arranged within a second winding of the at least two windings.

7. The method of claim 2, wherein a first winding of the at least two windings is arranged outside of a second winding of the at least two windings.

8. The method of claim 1, wherein the antenna comprises two windings; a first winding of the two windings configured for NFC charging of the second NFC device and a second winding of the two windings configured for NFC detection and communication with the third NFC device.

9. The method of claim 8, wherein the antenna comprises a third winding in series with the first winding and the second winding, wherein the third winding is configured for NFC charging of a fourth NFC device.

10. The method of claim 1 further comprising: implementing, as a result of the detection and by the NFC controller, a polling mode.

11. The method of claim 1 further comprising: resuming, at an end of the communication, the mode of charge.

12. A cell phone comprising a device configured to implement the method of claim 1.

13. A system comprising:
the cell phone of claim 12;
the second NFC device; and
the third NFC device.

14. The system of claim 13, wherein the second NFC device is a stylus.

15. The system of claim 13 further comprising a fourth NFC device, wherein the second NFC device is configured to emit sounds and the fourth NFC device is configured to emit sounds.

16. An NFC device comprising:
an NFC controller coupled to an antenna;
wherein the NFC controller is configured to:
interrupt a mode of charge of a second remote NFC device by the antenna as a result of a detection, by the NFC controller, of an impedance change of the antenna; and
start, following the interrupt, a communication with a third remote NFC device via the antenna.

17. The NFC device of claim 16, wherein the antenna comprises at least two windings in series.

18. The NFC device of claim 17, wherein each of the at least two windings in series comprise a plurality of turns.

19. The NFC device of claim 18, wherein a number of turns of a first winding of the at least two windings is from 6 to 8 turns.

20. The NFC device of claim 17, wherein a first winding of the at least two windings in series defines a first surface and a second winding defines a second surface, wherein the first surface is at least twice as large as the second surface.
